(19) United States
(12) Patent Application Publication
(10) Pub. No.: US 2015/0101561 A1
(43) Pub. Date: Apr. 16, 2015

(54) AIR CLEANER IN VEHICLE

(71) Applicant: Hyundai Motor Company, Seoul (KR)

(72) Inventors: Hanshin CHUNG, Yongin-si (KR); Joonho LEE, Seoul (KR); Hyun CHO, Seoul (KR); Jong Woo NAM, Seoul (KR)

(73) Assignee: Hyundai Motor Company, Seoul (KR)

(21) Appl. No.: 14/139,777

(22) Filed: Dec. 23, 2013

(30) Foreign Application Priority Data
Oct. 10, 2013 (KR) 10-2013-0120741

(51) Int. Cl. F02M 35/04

(52) U.S. Cl. CPC F02M 35/048
USPC 123/198 E

(57) ABSTRACT

An air cleaner apparatus mounted in a vehicle having an engine room encapsulation structure formed to surround an upper side, a lower side, lateral sides, and a rear side of an engine in an engine room, may include a filter provided at a side of the engine room encapsulation structure to receive air from an outside of the engine room encapsulation structure, and remove foreign matter from the air, a housing enclosing the filter and receiving the air passed through the filter, and an air intake hose connected to an end of the housing and configured for supplying the air passed through the housing to the engine as intake air.

### CROSS-REFERENCE TO RELATED APPLICATION

The present application claims priority to Korean Patent Application No. 10-2013-0120741 filed on Oct. 10, 2013, the entire contents of which is incorporated herein for all purposes by this reference.

### BACKGROUND OF THE INVENTION

1. Field of the Invention

The present invention relates to an air cleaner in a vehicle. More particularly, the present invention relates to an air cleaner in a vehicle applicable to a vehicle having a simple structure and an engine room encapsulation structure.

2. Description of Related Art

In general, the air cleaner in the vehicle has a function of removing dust from engine air intake. And, depending on the function of the air cleaner, an intake sound may be reduced.

Depending on a kind of element built in the air cleaner, there are dry type and wet type air cleaners. The dry air cleaner uses an element of paper or fiber material, and the wet air cleaner uses oil as the element. Though most of the air cleaner is the dry type, when replacement of the element is difficult in view of a mounting place, and a given maintenance condition, the wet type air cleaner is used

Accordingly, the dry type air cleaner is mostly used for the air cleaner in the vehicle in which replacement of the element is easy.

In the meantime, the lower the temperature of the engine air intake within a preset range, the higher the density of the air, to improve an engine output. Therefore, the vehicle is required to have devices for supplying outdoor air to the engine from an outside of the vehicle for securing cold air engine intake. And, an air storage space may be required for storing the outdoor air supplied from the outside of the vehicle to clean and supply the air as required. In this case, the air storage space may be an element, such as an air tank. Moreover, a size of the air storage space may become larger in proportion to an exhaust rate of the engine.

However, the larger the size of the air storage space, the poorer the spatial utilization of the engine room. And, weight of the devices for having the outdoor air supplied to the engine and weight of the air storage space increase weight of the vehicle, and make fuel consumption poor.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an air cleaner in a vehicle, which has a simple structure and reduced weight.

And, another object of the present invention is to provide an air cleanser in a vehicle, which is applicable to a vehicle having an engine room encapsulation structure.

In an aspect of the present invention, an air cleaner apparatus mounted in a vehicle having an engine room encapsulation structure formed to surround an upper side, a lower side, lateral sides, and a rear side of an engine in an engine room, may include a filter provided at a side of the engine room encapsulation structure to receive air from an outside of the engine room encapsulation structure, and remove foreign matter from the air, a housing enclosing the filter and receiving the air passed through the filter, and an air intake hose connected to an end of the housing and configured for supplying the air passed through the housing to the engine as intake air.

The housing may have a box shape having an opened side, and the filter is mounted to the opened side.

The engine room encapsulation structure may have an side having a hole formed therein for making an inside and an outside of the engine room encapsulation structure to be in communication with each other therethrough, wherein the filter and the housing are arranged such that the hole is positioned between the filter and the opened side of the housing, and wherein the air passed through the filter is introduced to the housing through the hole.

The opened side of the housing, the filter and a cross section of the hole may have shapes matched to one another.

The air cleaner apparatus may further include a hole passed through a side of the engine room encapsulation structure for introducing the air on an outside of the engine room encapsulation structure to the engine as intake air passed through the filter, the hole, the housing and the air intake hose in succession.

The hole is formed to pass through a side of the engine room encapsulation structure which surrounds a side of the engine.

The housing forms an inside space for storing the air passed through the filter, temporarily.

The air intake hose may have one end connected to one end of the housing to make the air intake hose to communicate with the inside space of the housing, and the other end in communication with an intake passage of the engine.

The engine room encapsulation structure may have an outside in communication with an outside of the vehicle for having outdoor air supplied thereto from the outside of the vehicle, and the filter may have the outdoor air having supplied to the outside of the engine room encapsulation structure supplied thereto, directly.

The filter is exposed to the outside of the engine room encapsulation structure, and a portion of the foreign matter filtrated by the filter falls down and is discharged to the lower side of the vehicle body by gravity.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a schematic view of an engine room encapsulation structure provided to a vehicle having an air cleaner in a vehicle in accordance with an exemplary embodiment of the present invention applied thereto.

FIG. 2 illustrates a schematic view of an engine room having an air cleaner in a vehicle in accordance with an exemplary embodiment of the present invention applied thereto.

FIG. 3 illustrates a perspective view of an air cleaner in a vehicle in accordance with an exemplary embodiment of the present invention seen from an inside of an engine room encapsulation structure.

FIG. 4 illustrates a perspective view of an air cleaner in a vehicle in accordance with an exemplary embodiment of the present invention seen from an outside of an engine room encapsulation structure.

FIG. 5 illustrates a plan view of an air cleaner in a vehicle in accordance with an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

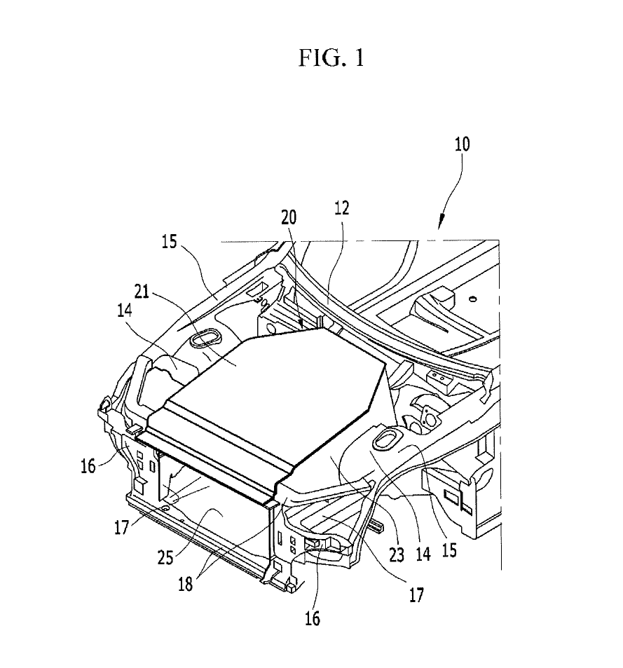

FIG. 1 illustrates a schematic view of an engine room encapsulation structure provided to a vehicle having an air cleaner in a vehicle in accordance with an exemplary embodiment of the present invention applied thereto.

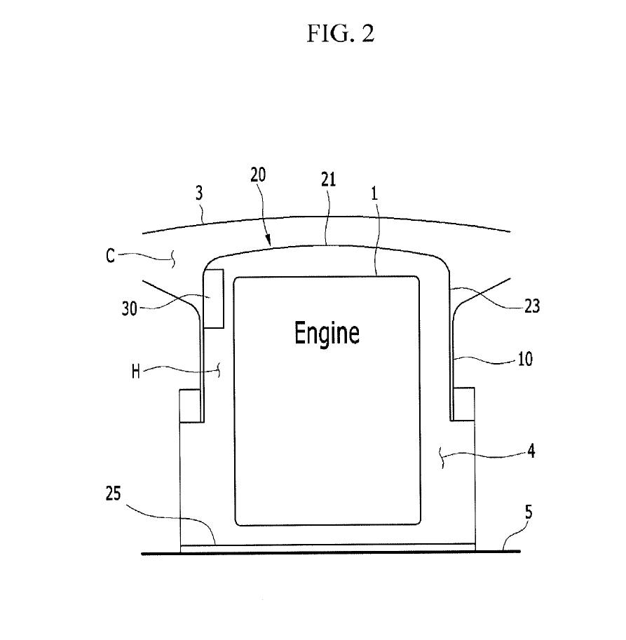

Referring to FIG. 1, the vehicle having an air cleaner in a vehicle in accordance with an exemplary embodiment of the present invention applied thereto is provided with engine room encapsulation structure 20. And, the engine room encapsulation structure 20 is installed to a vehicle body to encapsulate the engine 1 (See FIG. 2).

In this case, the engine room encapsulation structure 20 is an engine 1 shielding device for suppressing dissipation of heat from the engine 1 to an outside of engine for conserving a temperature of the engine 1 and minimizing fuel consumption at an initial starting of the engine 1.

The vehicle body 10 includes a cowl 12, a fender apron upper member 15, a fender apron reinforce member 16, a front end module 18, a front side member 17, and a shock absorber housing 14.

The cowl 12 is a panel connected to a front of the front glass of the vehicle. Or, the cowl 12 may be extended from a dashboard or mounted to the dashboard.

The fender apron upper member 15 is an upper member of a fender apron. That is, the fender apron upper member 15 is provided to an upper side of the fender apron which serves as a partition of a wheel and the engine room on an inner side of the fender which is a mudguard.

The fender apron reinforce member 16 connects the fender apron to other members of the vehicle body 10 for reinforcing stiffness of the fender apron. In the meantime, FIG. 1 illustrates the fender apron reinforce member 16 connected between the fender apron upper member 15 and the front end module 18.

The front side member 17 is a beam which forms a frame of the front body provided under a front floor and the dashboard taking a longitudinal direction of the vehicle body 10 as a length direction thereof.

The shock absorber housing 14 is a portion shock absorbers are mounted therein arranged between the fender apron upper member 15 and the front side member 17.

The front end module 18 is a member having different parts of a front of the vehicle body 10 constructed into one module. That is, the front end module 18 is arranged to a front most side of the front body.

Since the members of the vehicle body 10, which construe the front body, are apparent to those skilled in this field of art, detailed description of which will be omitted.

The engine room encapsulation structure 20 includes a side shielding unit 23, an upper side shielding unit 21, and a lower side shielding unit 25.

The side shielding unit 23 shields sides, and a rear of the engine room connected to the vehicle body 23. And the side shielding unit 23 has opened front, upper and lower sides. In this case, the upper, lower, front, and rear directions are with reference to upper, lower, front, and rear directions of the vehicle body.

The upper shielding unit 21 is arranged to cover the side shielding unit from the opened upper side of the side shielding unit 23. That is, the upper shielding unit 21 shields an upper side of the engine room. And, the upper shielding unit 21 has one end mounted to the front end module 18, and the side shielding unit 23 has one end mounted to the front side member 17.

The lower shielding unit 25 is provided to shield an underside of the engine room 4. Referring to FIG. 2, the lower shielding unit 25 is mounted to an under guard 5. And, the lower shielding unit 25 may be formed to have a surface arranged on the same plane with the under guard 5. In this case, the under guard 5 is a plate for protecting a running gear at a lower side and an underside of the engine 1. The under guard 5 has one front end connected to the front end module 18 extended to a rear side passed through front wheels of the vehicle. Moreover, the lower shielding unit 25 may be formed as a large plate extended in a length direction of the under guard 5. Accordingly, the lower shielding unit 25 may cover, not only the underside of the engine 1, but also different units on a lower side of the vehicle.

The side shielding unit 23, the upper shielding unit 21, and the lower shielding unit 25 may be formed as one unit or individually and assembled together.

FIG. 2 illustrates a schematic view of an engine room having an air cleaner in a vehicle in accordance with an exemplary embodiment of the present invention applied thereto.

Referring to FIG. 2, the air cleaner 30 in a vehicle in accordance with an exemplary embodiment of the present invention is connected to the engine room encapsulation structure 20.

Though FIGS. 2 to 5 illustrate the air cleaner 30 mounted to the side shielding unit 23 of the engine room encapsulation structure 20, the present invention is not limited to this. In other words, the air cleaner 30 may be mounted to the upper shielding unit 21 of the engine room encapsulation structure 20 or the vehicle body 10. However, the air cleaner 30 is provided to receive the air from an outside of the engine room encapsulation structure 20.

The engine room 4 is a space which the engine 1 is arranged therein. The engine room 4 has an upper side closed by a hood 3 which is also called as bonnet, sides closed by the vehicle body 10, and a lower side closed by the under guard 5. Since the engine room 4, surrounded with the hood 3, the vehicle body 10, and the under guard 5, is apparent to a person skilled in this field of art, more detailed description will be omitted.

In the meantime, the engine room 4 is partitioned with the engine room encapsulation structure 20. As the engine room encapsulation structure 20 is arranged to encapsulate the engine 1 in the engine room 4, the engine room 4 is partitioned into an outside and an inside of the engine room encapsulation structure 20. And, since the engine room encapsulation structure 20 suppresses the heat from dissipating from the engine 1, the inside of the engine room encapsulation structure 20 becomes a high temperature area (Hot area, H) where an air temperature is high relatively, and the outside of the engine room encapsulation structure 20 becomes a low temperature area (Cold area, C) where an air temperature is low, relatively.

As described before, the air cleaner 30 is provided to receive the air from the low temperature area C. Accordingly, the devices for making the air cleaner 30 to receive outdoor air from the outside of the vehicle may be eliminated. In other words, the duct and the like which is an air passage in communication with the outside of the vehicle for the air cleaner 30 to receive the outdoor air from the outside of the vehicle may be eliminated.

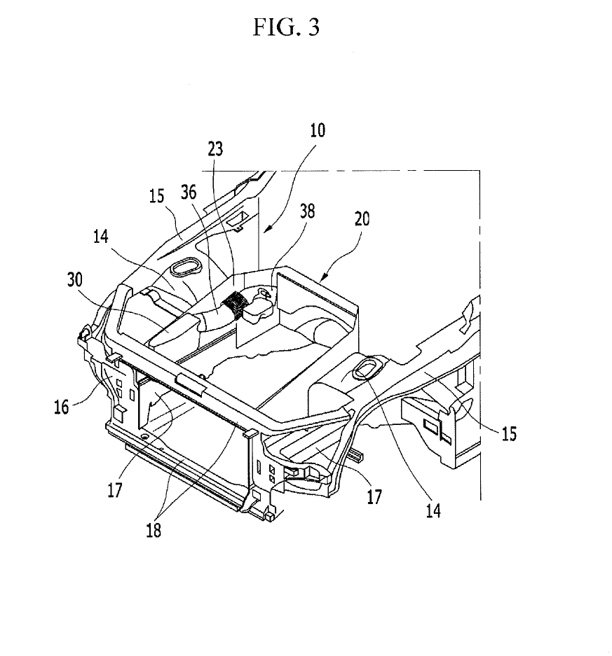

Hereafter, the air cleaner 30 in a vehicle in accordance with an exemplary embodiment of the present invention will be described with reference to FIGS. 3 to 5, in detail.

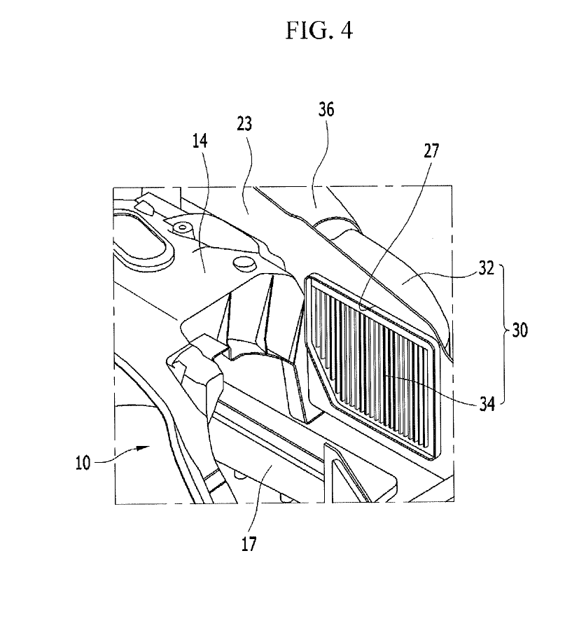

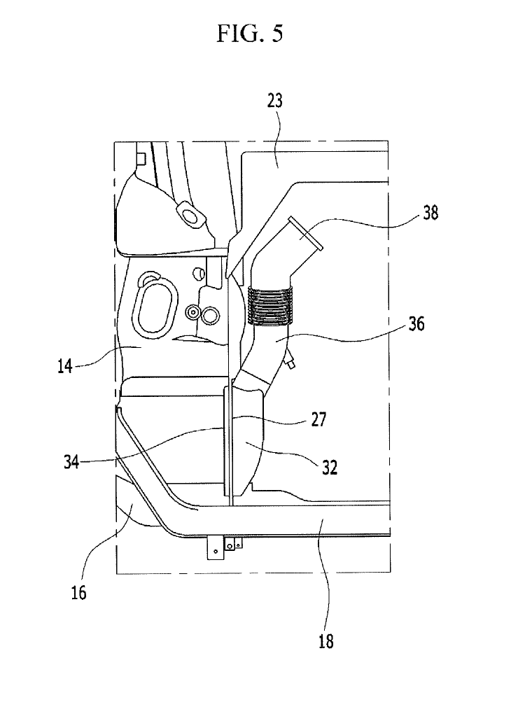

FIG. 3 illustrates a perspective view of an air cleaner in a vehicle in accordance with an exemplary embodiment of the present invention seen from an inside of an engine room encapsulation structure, FIG. 4 illustrates a perspective view of an air cleaner in a vehicle in accordance with an exemplary embodiment of the present invention seen from an outside of an engine room encapsulation structure, and FIG. 5 illustrates a plan view of an air cleaner in a vehicle in accordance with an exemplary embodiment of the present invention.

Referring to FIGS. 3 to 5, the air cleaner 30 in a vehicle in accordance with an exemplary embodiment of the present invention includes a housing 32, a filter 34, an air intake hose 36, and an air outlet 38.

The housing 32, being a cover of the filter 34, has a box shape for securing an inside space to store the air received from the low temperature area C therein, temporarily. And, the housing 32 is formed in a box shape having an opened one side, and has one end connected to the air intake hose 36. Moreover, the opened one side of the housing 32 is connected to the engine room encapsulation structure 20 for receiving the air from the low temperature area C.

In the meantime, the engine room encapsulation structure 20 has a communication hole 27 formed therein for making the opened one side of the housing 32 to communicate with the low temperature area C.

Though FIGS. 4 and 5 illustrate the communication hole 27 formed in the side shielding unit 23 and the opened one side of the housing 32 connected to the side shielding unit 23, the communication hole 27 may be formed in the upper shielding unit 21 and the opened one side of the housing 32 may be connected to the upper shielding unit 21.

The filter 34 is arranged to the opened one side of the housing 32. And, the filter 34 is arranged to close the opened one side of the housing 32 exposed to the low temperature area C.

In this case, the communication hole 27 is arranged between the filter 34 and the opened one side of the housing 32. And, the opened one side of the housing 32, the filter 34, and a cross section of the communication hole 27 may be formed to have shapes matched to one another. Moreover, the air is introduced to the inside space of the housing 32 through the filter 34. That is, the filter 34 serves as an inlet through which the air is introduced to the air cleaner 30. In this case, foreign matter, such as dust, mixed in the air in the low temperature area C is removed by the filter 34 to introduce cleaned air into the housing 32.

In the meantime, as the foreign matter, such as dust, in the air in the low temperature area C is filtrated by the filter 34, and a portion of the foreign material filtrated thus may fall down to be discharged to the outside of the vehicle through the lower side of the vehicle body 10 by gravity. According to this, an element of the air cleaner 30 for collecting the foreign matter filtrated by the filter 34 thus may be eliminated.

The air intake hose 36 has one end connected to one end of the housing 32 for making the intake hose 36 to be in communication with an inside space of the housing 32. And, the air intake hose 36 is formed to be extended to an intake passage of the engine 1 for supplying the air introduced to the inside space of the housing 32 to the engine 1.

The air outlet 38 is formed at the other end of the intake hose 36. And, the air outlet 38 is an outlet of the air from the air cleaner 30. Moreover, the air outlet 38 is connected to the intake passage of the engine 1. According to this, the air introduced to the inside space of the housing 32 from the low temperature area C is supplied to the engine 1 as intake air.

In the meantime, the air in the low temperature area C may be outdoor air introduced from the outside of the vehicle through a radiator grill . According to this, the air cleaner 30 receiving the air from the low temperature area C may provide to have the same effect with the air cleaner 30 receiving the outdoor air from the outside of the vehicle. And, since the air introduced from the outside of the vehicle is brought into contact with the filter 34 directly via the low temperature area C, a portion of the cover which covers the filter 34 may be eliminated. Moreover, since the air cleaner 30 receives the outdoor air from the low temperature area C directly, the air storage space for securing and storing the outdoor air may be eliminated.

As described before, in accordance with an exemplary embodiment of the present invention, by eliminating the devices for receiving outdoor air from the outside of the vehicle and the air storage space, weight of the vehicle can be reduced, and the fuel consumption can be improved. And, as the space occupied by the air cleaner 30 is reduced in the engine room, spatial utility of the inside of the engine room can be enhanced. Moreover, the elimination of a few elements of the air cleaner 30 which are required to be designed taking interference with other elements in the engine room 4 into account permits to improve a design freedom of the air cleaner 30, and interchangeability of the air cleaner 30 with respect to the filter 34 among vehicles can be improved.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. An air cleaner apparatus mounted in a vehicle having an engine room encapsulation structure formed to surround an upper side, a lower side, lateral sides, and a rear side of an engine in an engine room, the air cleaner apparatus comprising:
a filter provided at a side of the engine room encapsulation structure to receive air from an outside of the engine room encapsulation structure, and remove foreign matter from the air;
a housing enclosing the filter and receiving the air passed through the filter; and
an air intake hose connected to an end of the housing and configured for supplying the air passed through the housing to the engine as intake air.

2. The air cleaner apparatus of claim 1, wherein the housing has a box shape having an opened side, and the filter is mounted to the opened side.

3. The air cleaner apparatus of claim 1,
wherein the engine room encapsulation structure has an side having a hole formed therein for making an inside and an outside of the engine room encapsulation structure to be in communication with each other therethrough,
wherein the filter and the housing are arranged such that the hole is positioned between the filter and the opened side of the housing, and
wherein the air passed through the filter is introduced to the housing through the hole.

4. The air cleaner apparatus of claim 3, wherein the opened side of the housing, the filter and a cross section of the hole have shapes matched to one another.

5. The air cleaner apparatus of claim 1, further comprising a hole passed through a side of the engine room encapsulation structure for introducing the air on an outside of the engine room encapsulation structure to the engine as intake air passed through the filter, the hole, the housing and the air intake hose in succession.

6. The air cleaner apparatus of claim 5, wherein the hole is formed to pass through a side of the engine room encapsulation structure which surrounds a side of the engine.

7. The air cleaner apparatus of claim 1, wherein the housing forms an inside space for storing the air passed through the filter, temporarily.

8. The air cleaner apparatus of claim 7, wherein the air intake hose has one end connected to one end of the housing to make the air intake hose to communicate with the inside space of the housing, and the other end in communication with an intake passage of the engine.

9. The air cleaner apparatus of claim 1,
wherein the engine room encapsulation structure has an outside in communication with an outside of the vehicle for having outdoor air supplied thereto from the outside of the vehicle, and
wherein the filter has the outdoor air having supplied to the outside of the engine room encapsulation structure supplied thereto, directly.

10. The air cleaner apparatus of claim 9,
wherein the filter is exposed to the outside of the engine room encapsulation structure, and
wherein a portion of the foreign matter filtrated by the filter falls down and is discharged to the lower side of the vehicle body by gravity.
